(19) United States
(12) Patent Application Publication
(10) Pub. No.: US 2026/0100345 A1
(43) Pub. Date: Apr. 9, 2026

(54) MANUFACTURING METHOD OF BATTERY

(71) Applicant: TOYOTA JIDOSHA KABUSHIKI KAISHA, Toyota-shi (JP)

(72) Inventors: Masato ONO, Nagoya-shi (JP); Tadashi TERANISHI, Toyota-shi (JP); Yusuke OISHI, Toyota-shi (JP)

(73) Assignee: TOYOTA JIDOSHA KABUSHIKI KAISHA, Toyota-shi (JP)

(21) Appl. No.: 19/220,740

(22) Filed: May 28, 2025

(30) Foreign Application Priority Data
Oct. 4, 2024 (JP) 2024-175040

(51) Int. Cl. H01M 4/04; H01M 4/02; H01M 4/36

(52) U.S. Cl. CPC H01M 4/043; H01M 4/366; H01M 2004/029

(57) ABSTRACT

The method of the present disclosure for manufacturing a battery includes roller conveying a heated elongated sheet-like bipolar electrode laminate with a conveying roller. In the method of the present disclosure, the temperature drop of the bipolar electrode laminate when the bipolar electrode laminate passes through the conveying roller is 30° C. or higher, and further includes pressing the bipolar electrode laminate by the pressing roller before the bipolar electrode laminate passes through the conveying roller, wherein the temperature drop of the bipolar electrode laminate when the bipolar electrode laminate passes through the pressing roller is less than 30° C., and the pressing roller has a protruding portion at a position overlapping the gap portion or the opposite side surface of the bipolar electrode laminate, and the bipolar electrode laminate passes through the pressing roller so that the stretching stress in the transverse direction is applied to the gap portion.

### CROSS-REFERENCE TO RELATED APPLICATION

This application claims priority to Japanese Patent Application No. 2024-175040 filed on Oct. 4, 2024. The disclosure of the above-identified application, including the specification, drawings, and claims, is incorporated by reference herein in its entirety.

### BACKGROUND

### 1. Technical Field

The present disclosure relates to a manufacturing method of a battery.

### 2. Description of Related Art

As disclosed in Japanese Unexamined Patent Application Publication No. 2017-228349 (JP 2017-228349 A) and Japanese Unexamined Patent Application Publication No. 2009-298496 (JP 2009-298496 A), technology for suppressing occurrence of wrinkles in an electrode laminate that is conveyed by a roller is known.

Japanese Unexamined Patent Application Publication No. 2023-073069 (JP 2023-073069 A), Japanese Unexamined Patent Application Publication No. 2022-066723 (JP 2022-066723 A), Japanese Unexamined Patent Application Publication No. 2009-049006 (JP 2009-049006 A), and Japanese Unexamined Patent Application Publication No. 2022-139880 (JP 2022-139880 A) disclose an electrode laminate having a gap portion that is formed in-plane in an electrode active material layer.

### SUMMARY

The present disclosers have found that, in manufacturing of a bipolar electrode laminate having a gap portion that is formed in-plane in one electrode active material layer, cracks readily occur in the other electrode active material layer on the opposite side face of this gap portion during roller conveying.

An object of the present disclosure is to provide a manufacturing method of a battery that is capable of suppressing such cracking of an electrode active material layer.

The present disclosers found that the above issue can be solved by the following measures.

A manufacturing method of a battery, the manufacturing method including performing roller conveying, by a conveying roller, of a bipolar electrode laminate that is an elongated sheet and that is heated, in which
the bipolar electrode laminate includes a first electrode active material layer, a current collector layer, and a second electrode active material layer, in this order,
the first electrode active material layer is made up of a plurality of island portions extending in a conveying direction, with at least one gap portion extending in the conveying direction among the island portions,
a temperature decrease of the bipolar electrode laminate when the bipolar electrode laminate passes over the conveying roller is no less than 30° C.,
the manufacturing method further includes pressing the bipolar electrode laminate with a pressing roller prior to the bipolar electrode laminate passing over the conveying roller,
a temperature decrease of the bipolar electrode laminate when the bipolar electrode laminate passes over the pressing roller is less than 30° C., and
the pressing roller includes a protruding portion at a position overlapping with the gap portion or an opposite side face from the gap portion, such that stretching stress in a lateral direction is applied to the gap portion when the bipolar electrode laminate passes over the pressing roller.

In the manufacturing method described above, a width of the protruding portion is no greater than a width of the gap portion.

In the manufacturing method described above, a cross-sectional shape of the protruding portion is a rounded square.

The manufacturing method described above further includes drying the first electrode active material layer and the second electrode active material layer by laser heating prior to the pressing.

The manufacturing method described above further includes pressing the bipolar electrode laminate prior to the drying.

According to the manufacturing method of the present disclosure for manufacturing a battery, cracks can be suppressed from occurring in the electrode active material layer, as described above.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a method of the present disclosure;

FIG. 2 is a schematic cross-sectional view illustrating an example of a bipolar electrode laminate according to the method of the present disclosure;

FIG. 3 is a schematic top view of an exemplary disclosed process; and

FIG. 4 is a schematic cross-sectional view illustrating an example of a method of the present disclosure.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Manufacturing Method of Battery

The method of the present disclosure for manufacturing a battery includes roller conveying a heated elongated sheet-like bipolar electrode laminate with a conveying roller. In the method of the present disclosure, the bipolar electrode laminate has a first electrode active material layer, a current collector layer, and a second electrode active material layer in this order, and the first electrode active material layer is composed of a plurality of island portions extending in the transport direction, and at least one gap portion extending in the transport direction is present between the plurality of island portions, and when the bipolar electrode laminate passes through the conveying roller, the temperature drop of the bipolar electrode laminate is 30° C. or more, and before the bipolar electrode laminate passes through the conveying roller The method further includes pressing the bipolar electrode laminate with a pressing roller, wherein a temperature drop of the bipolar electrode laminate when the bipolar electrode laminate passes through the pressing roller is less than 30° C., and the pressing roller has a protruding portion at a position overlapping the gap portion or the opposite side surface. Thereby, a transverse stretching stress is applied to the gap portion when the bipolar electrode laminate passes through the pressing roller.

As described above, in the production of the bipolar electrode laminate having the gap portion formed in the surface of one of the electrode active material layers (the first electrode active material layer), the present disclosure has found that cracks tend to occur in the other electrode active material layer (the second electrode active material layer) on the opposite side surface of the gap portion during roller conveyance.

The inventors of the present disclosure considered that one of the causes of the cracking of the second electrode active material layer on the opposite side surface of the gap portion is caused by the thermal shrinkage. That is, when the heated long sheet-shaped bipolar electrode laminate is conveyed by the conveying roller, the temperature of the bipolar electrode laminate is considered to be lowered by the conveying roller. It is considered that the gap portion of the bipolar electrode laminate has a smaller rigidity than the other portions, and therefore wrinkles due to heat shrinkage occur in the gap portion. It is considered that the wrinkles generated in this manner interfere with the conveying roller, and thus the second electrode active material layer is cracked on the opposite side surface of the gap portion.

On the other hand, the Disclosing Party has found that, even if the temperature of the bipolar electrode laminate is lowered by the conveying roller, the bipolar electrode laminate further includes pressing the bipolar electrode laminate by the pressing roller before the bipolar electrode laminate passes through the conveying roller, the temperature decrease of the bipolar electrode laminate when the bipolar electrode laminate passes through the pressing roller is relatively small, the pressing roller has a protruding portion at a position overlapping with the gap portion or the opposite side surface thereof, and thereby, when the bipolar electrode laminate passes through the pressing roller, the stretching stress in the transverse direction is applied to the gap portion, whereby the occurrence of cracks in the second electrode active material layer on the opposite side surface of the gap portion can be suppressed. The reason for this is estimated as follows. In other words,

When passing through the pressing roller, the temperature drop of the bipolar electrode laminate is relatively small, so that heat shrinkage in the gap portion can be prevented from occurring; and

Since the gap portion is stretched in advance by the pressing roller, heat shrinkage at the gap portion when passing through the conveying roller can be canceled, thereby suppressing occurrence of wrinkles

This is considered to be the reason.

Hereinafter, a method of manufacturing an electrode according to the present disclosure will be described with reference to the drawings. The dimensional relationship in the drawings does not reflect the actual dimensional relationship.

### Roller Transport

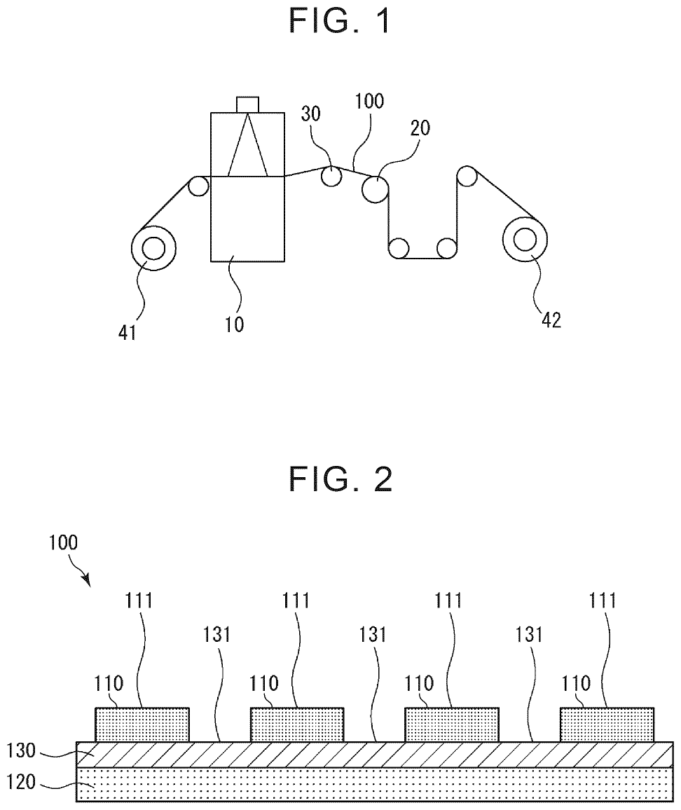

As illustrated in FIG. 1, the method of the present disclosure includes roller-conveying a heated elongated sheet-like bipolar electrode laminate 100 with a conveying roller 20. Note that FIG. 1 is a schematic diagram illustrating an embodiment in which the bipolar electrode laminate is wound on the winding reel 42 from the unwinding reel 41 via heating (drying) by the laser irradiation device 10 and roller conveyance by the conveying roller 20.

The heating temperature is not particularly limited, but may be, for example, 120° C. or higher, 130° C. or higher, 140° C. or higher, 150° C. or higher, 160° C. or higher, 170° C. or higher, 180° C. or higher, 190° C. or higher, or 200° C. or higher, and may be 300° C. or lower, 290° C. or lower, 280° C. or lower, 270° C. or lower, 260° C. or lower, or 250° C. or lower. When the heating temperature is within the above range, it is considered that the temperature of the bipolar electrode laminate 100 is easily lowered by the conveying roller 20 when the bipolar electrode laminate 100 is conveyed by the conveying roller 20. Based on such an estimation, it is particularly effective to apply the method of the present disclosure to a bipolar electrode laminate heated at a temperature within the above range.

As illustrated in FIG. 2, in the method of the present disclosure, the bipolar electrode laminate includes a first electrode active material layer 110, a current collector layer 130, and a second electrode active material layer 120 in this order.

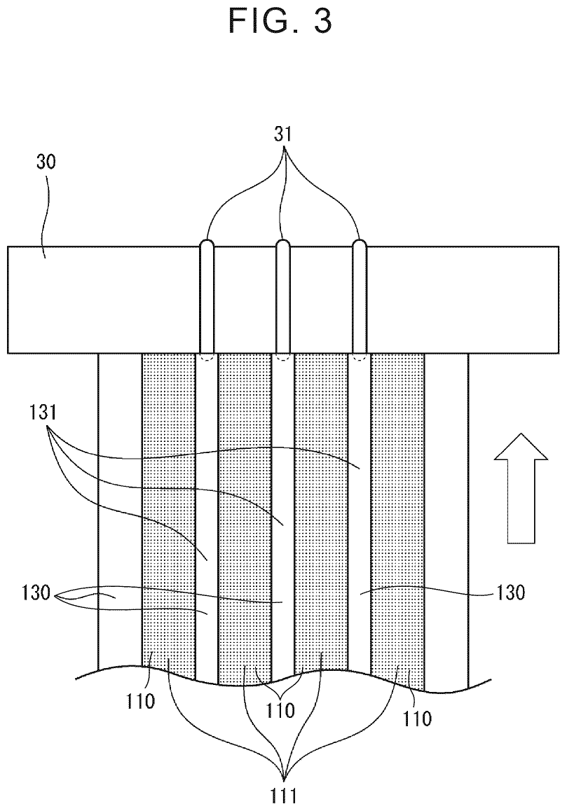

As illustrated in FIGS. 2 and 3, in the method of the present disclosure, the first electrode active material layer 110 is composed of a plurality of island portions 111 extending in the transport direction, and there is at least one gap portion 131 extending in the transport direction between the plurality of island portions. The conveying direction is indicated by an arrow in FIG. 3.

The number of the island portions 111 and the gap portions 131 is not particularly limited. For example, when the number of the gap portions 131 is n, the number of island portions may be n+1. In this case, n is not particularly limited, but may be 1, 2, 3, 5, 7, 9, or 10 or more, 30, 25, 20, or 15 or less.

The gap portion 131 may extend over the entire bipolar electrode laminate 100 in the transport direction of the bipolar electrode laminate 100 and may extend over a portion of the bipolar electrode laminate 100.

The first electrode active material layer 110 composed of the plurality of island portions 111 may be a positive electrode active material layer or a negative electrode active material layer, and in particular, may be a positive electrode active material layer. The second electrode active material layer 120 may be a positive electrode active material layer or a negative electrode active material layer, and particularly may be a negative electrode active material layer.

In the method of the present disclosure, the temperature drop of the bipolar electrode laminate 100 when the bipolar electrode laminate passes through the conveying roller 20 is 30° C. or higher.

The temperature decrease of the bipolar electrode laminate 100 may be caused by the lower temperature of the conveying roller 20 than the temperature of the heated bipolar electrode laminate 100.

The temperature drop of the bipolar electrode laminate 100 may be 40° C. or higher, 50° C. or higher, 60° C. or higher, 70° C. or higher, 80° C. or higher, 90° C. or higher, or 100° C. or higher, and may be 150° C. or lower, 130° C. or lower, or 110° C. or lower. When the temperature drop of the bipolar electrode laminate 100 is within the above range, thermal shrinkage in the gap portion 131 of the bipolar electrode laminate 100 is likely to occur, and therefore, the method of the present disclosure is of great significance.

The temperature of the bipolar electrode laminate may be monitored by a thermometer, such as a temperature sensor. The thermometer may in particular be a non-contact radiation thermometer.

As illustrated in FIG. 1, the method of the present disclosure further includes pressing the bipolar electrode laminate 100 with the pressing roller 30 before the bipolar electrode laminate 100 passes through the conveying roller 20, wherein the temperature drop of the bipolar electrode laminate 100 as the bipolar electrode laminate 100 passes through the pressing roller 30 is less than 30° C. That is, when the bipolar electrode laminate 100 passes through the pressing roller 30, the temperature drop of the bipolar electrode laminate 100 is relatively small. With such a configuration, when the bipolar electrode laminate 100 passes through the pressing roller 30, it is possible to suppress the occurrence of heat shrinkage in the gap portion 131 of the bipolar electrode laminate 100.

In order to ensure that the temperature drop of the bipolar electrode laminate 100 when the bipolar electrode laminate 100 passes through the pressing roller 30 is less than 30° C., the pressing roller 30 may be a roller having at least a surface formed of a heat insulating material, a temperature-adjustable roller, or the like.

The heat insulating material is not particularly limited as long as the heat transfer between the bipolar electrode laminate 100 and the pressing roller 30 can be suppressed.

The temperature-adjustable roller may have, for example, a heating section. The heating unit may be, for example, a heater.

When the bipolar electrode laminate 100 passes through the pressing roller 30, the temperature drop of the bipolar electrode laminate 100 may be 25° C. or less, 20° C. or less, 15° C. or less, 10° C. or less, 5° C. or less, 3° C. or less, or 1° C. or less, and this temperature drop may not occur. When the temperature drop is within the above range, the occurrence of cracks in the second electrode active material layer 120 on the opposite side surface of the gap portion 131 can be suppressed more effectively.

For example, in a case where a temperature-adjustable roller is used as the pressing roller 30, the temperature of the temperature-adjustable roller is set to be equal to or higher than the temperature of the bipolar electrode laminate 100, so that this temperature decrease is not caused. In this case, the temperature of the temperature adjustable roller can be appropriately set so that an excessive temperature rise of the bipolar electrode laminate 100 does not occur when the bipolar electrode laminate 100 passes through the pressing roller 30.

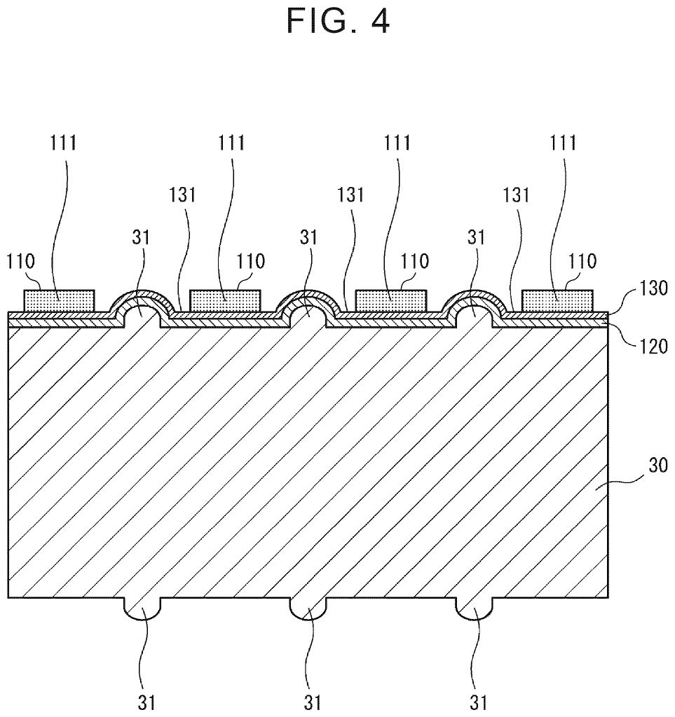

As illustrated in FIGS. 3 and 4, in the method of the present disclosure, the pressing roller 30 has a protruding portion 31 at a position overlapping with the gap portion 131 or an opposite side surface thereof. As a result, when the bipolar electrode laminate 100 passes through the pressing roller 30, a stretching stress in the transverse direction is applied to the gap portion 131. With such a configuration, it is possible to suppress the occurrence of cracks in the second electrode active material layer 120 on the opposite side surface of the gap portion 131. In the embodiment illustrated in FIG. 3, the bipolar electrode laminate 100 is pressed against the pressing roller 30 such that the second electrode active material layer 120 side of the bipolar electrode laminate 100 is in contact with the pressing roller 30. In FIG. 3, the bipolar electrode laminate 100 overlapping with the pressing roller 30 is omitted for the sake of explanation.

The position of the protruding portion 31 in the pressing roller 30 is not particularly limited as long as it is a position at which at least a part of the protruding portion overlaps with the gap portion 131 or the opposite side surface thereof. For example, as illustrated in FIG. 4, the position of the center of the protruding portion 31 and the position of the center of the gap portion 131 may substantially coincide with each other in the transverse direction of the gap portion 131.

As illustrated in FIGS. 3 and 4, in the method of the present disclosure, the width of the protruding portion 31 may be equal to or less than the width of the gap portion 131. With such a configuration, it is possible to suppress the protruding portion 31 from applying unnecessary stretching stress to a portion other than the gap portion of the bipolar electrode laminate. In the context of the present disclosure, “width” means the transverse length of the gap portion 131.

The width of the protruding portion 31 can be appropriately designed in consideration of the degree of wrinkles that may occur in the gap portion 131 and the like.

The width of the gap portion can be appropriately set in consideration of a desired battery capacity or the like.

The protruding portion 31 may be formed on a part of the outer periphery of the pressing roller 30, or may be formed over the entire outer periphery.

In the method of the present disclosure, the shape of the protruding portion 31 is not particularly limited. For example, the cross-sectional shape of the protruding portion 31 may be a quadrangular shape or a rounded square. Since the cross-sectional shape of the protruding portion 31 is a rounded square, it is possible to suppress the bipolar electrode laminate 100 from being damaged. For example, by the corners of the protruding portion 31 is rounded (R) chamfered, it is possible to form the protruding portion 31 having a rounded square shape. The radii of the R chamfers may be greater than or equal to 0.5 mm, greater than or equal to 1.0 mm, greater than or equal to 2.0 mm, or greater than or equal to 3.0 mm, and may be less than or equal to 10.0 mm, less than or equal to 7.0 mm, or less than or equal to 5.0 mm. As illustrated in FIG. 4, the entire surface of the protruding portion 31 may be a curved surface.

The material constituting the protruding portion 31 is not particularly limited, and may be, for example, the same material as the conveying roller or a different material. From the viewpoint of increasing the tensile stress applied to the gap portion and thereby more effectively suppressing the occurrence of cracks in the second electrode active material layer, the material is preferably a relatively hard material. From the viewpoint of suppressing damage to the bipolar electrode laminate, the material is preferably a relatively soft material.

Note that FIG. 3 illustrates an embodiment in which the second electrode active material layer 120 is disposed inside the pressing roller 30 in the radial direction, that is, on the side in contact with the pressing roller 30. However, in the method of the present disclosure, the first electrode active material layer 110 may be disposed on the side in contact with the pressing roller 30.

In the method of the present disclosure, the temperature of the bipolar electrode laminate at the time of roller conveyance is not particularly limited, but may be 40° C. or higher, 50° C. or higher, 60° C. or higher, 70° C. or higher, 80° C. or higher, 90° C. or higher, or 100° C. or higher, and may be 150° C. or lower, 140° C. or lower, 130° C. or lower, 120° C. or lower, 110° C. or lower, or 100° C. or lower. When the temperature is within the above range, the temperature of the bipolar electrode laminate tends to decrease, and therefore, the method of the present disclosure is of great significance.

When the bipolar electrode laminate 100 is conveyed by the conveying roller 20, the conveyance direction of the bipolar electrode laminate 100 may be changed by a predetermined angle or more. In this case, the length that can be brought into contact with the bipolar electrode laminate 100 and the conveying roller 20 becomes long, and therefore the temperature of the bipolar electrode laminate 100 tends to decrease, and thus the significance of applying the method of the present disclosure is great. The predetermined angle is not particularly limited, but may be, for example, 45° or more, 60° or more, 70° or more, 80° or more, 85° or more, or 90° or more, and may be 180° or less, 150° or less, 130° or less, 120° or less, 110° or less, 100° or less, 95° or less, or 90° or less.

### Drying

The method of the present disclosure may further include drying the first electrode active material layer 110 and the second electrode active material layer 120 by laser heating prior to pressing. According to the laser heating, the bipolar electrode laminate can be heated efficiently. During laser heating, air blowing may be used in combination. The blower may be hot air.

As illustrated in FIG. 1, laser heating may be performed by the laser irradiation device 10. Note that the laser heating and the roller conveyance may be performed continuously as illustrated in FIG. 1 or may be performed discontinuously.

When the first electrode active material layer and the second electrode active material layer are dried by laser heating, the target of laser irradiation may be any of the first and second electrode active material layers. When the first electrode active material layer is a positive electrode active material layer, in particular, the first electrode active material layer may be heated by irradiating a laser beam.

### Press

Although not shown, the method of the present disclosure may further include pressing the bipolar electrode laminate 100 prior to drying.

When the second electrode active material layer 120 includes a binder, it is considered that the binder is compacted in the second electrode active material layer 120 that has passed through the press, and thus the flexibility is reduced. Based on such estimation, it is particularly effective to apply the method of the present disclosure to the bipolar electrode laminate 100 that has undergone pressing.

The method of pressing is not particularly limited, and a conventional method can be adopted.

The pressure of the press is not particularly limited, and can be appropriately set so that the density of the electrode active material layer becomes a desired value.

### Low Temperature Drying

The method of the present disclosure may further include drying the first and second electrode active material layers at a temperature lower than the temperature in drying by laser heating described above prior to pressing. The drying temperature in this step may be 80° C. or higher, 90° C. or higher, or 100° C. or higher, and may be 140° C. or lower, 130° C. or lower, or 120° C. or lower.

### Battery

The battery of the present disclosure is manufactured by the method of the present disclosure for manufacturing a battery. In the battery of the present disclosure, the occurrence of cracking of the second electrode active material layer on the opposite side surface of the gap portion 131 of the bipolar electrode laminate 100 is suppressed.

The battery of the present disclosure includes a bipolar electrode laminate 100 and may optionally have an electrolyte layer.

The battery of the present disclosure may be a liquid-based battery or a solid-state battery. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

The battery of the present disclosure may be a primary battery or a secondary battery. In particular, it may be a lithium-ion secondary battery.

Hereinafter, each element constituting the battery will be described.

### Current Collector Layer

As the current collector layer, one known as a current collector layer of a battery can be employed. The current collector layer may be, for example, a copper foil, a copper alloy foil, a nickel foil, an aluminum foil, an aluminum alloy foil, a stainless steel foil, a carbon sheet, or the like.

The current collector layer may have two different current collector layers. In this case, the current collector layers may be bonded to each other via a conductive adhesive layer, or may be bonded by pressing or the like. For example, the current collector layer on the negative electrode active material layer side may be a copper foil, and the current collector layer on the positive electrode active material layer side may be an aluminum foil.

The thickness of the current collector layer is not particularly limited, but may be 1 μm or more and 300 μm or less, 5 μm or more and 200 μm or less, or 10 μm or more and 100 μm or less. If the current collector layer has two current collector layers which are bonded to each other via a conductive adhesive layer, the total thickness of each layer may be in the above range.

The size of the current collector layer is not particularly limited, and can be appropriately set in consideration of, for example, a desired capacity of the battery.

The shape of the current collector layer in the battery obtained by the method of the present disclosure is not particularly limited, but may be, for example, a rectangle such as a rectangle.

### First and Second Electrode Active Material Layers

The first and second electrode active material layers include an electrode active material, and may optionally include a binder, a conductive aid, and other components.

The electrode active material layer can be formed from an electrode mixture slurry.

In the context of the present disclosure, the term “mixture” means a composition capable of forming an electrode active material layer or the like as it is or by further containing other components. In addition, in the context of the present disclosure, a “mixture slurry” means a slurry that includes a dispersion medium in addition to a “mixture” and that can be applied and dried to form an electrode active material layer or the like.

The thickness of the electrode active material layer is not particularly limited. The thickness of the electrode active material layer may be 10 μm or more and 500 μm or less, 100 μm or more and 450 μm or less, or 200 μm or more and 400 μm or less.

The size of the electrode active material layer is not particularly limited, and can be appropriately set in consideration of, for example, a desired capacity of the battery.

The shape of the first and second electrode active material layers in the battery obtained by the method of the present disclosure is not particularly limited, but may be, for example, a rectangle such as a rectangle.

### Electrode Active Material

The electrode active material is not particularly limited. For the present disclosure, for example, when the first electrode active material layer is a positive electrode active material layer, the first electrode active material layer may include a positive electrode active material. Further, for example, when the second electrode active material layer is a negative electrode active material layer, the second electrode active material layer may include a negative electrode active material.

The positive electrode active material is not particularly limited as long as it has a noble potential as compared with the negative electrode active material. When the bipolar electrode laminate of the present disclosure is a bipolar electrode laminate for a lithium ion secondary battery, examples that can be used for a cathode active material include complex oxides such as lithium cobaltate (LiCoO₂), lithium nickelate (LiNiO₂), lithium manganate (LiMn₂O₄), solid solution oxide (Li₂MnO₃—LiMO₂ (M=Co, Ni, etc.)), lithium nickel manganate (LiNi_{1/2}Mn_{1/2}O₂), lithium nickel cobalt manganate (LiNi_{1/3}Mn_{1/3}Co_{1/3}O₂), olivine-type lithium phosphate (LiFePO₄), and so forth; conductive polymers such as polyaniline, polypyrrole, and so forth; sulfide cathode active materials such as Li₂S, CuS, Li—Cu—S compounds, TiS₂, FeS, MoS₂, Li—Mo—S compounds, Li—Ti—S compounds, Li-V-S compounds, and so forth; materials in which sulfur is an active material such as acetylene black impregnated with sulfur, porous carbon impregnated with sulfur, mixed powders of sulfur and carbon, and so forth; and the like. These positive electrode active materials may be used singly or in a combination of two or more.

The content of the positive pole active material in the positive pole gating material as an electrode material may be more than 50% mass, more than 70% mass, more than 90% mass, or more than 95% mass.

The shape of the positive electrode active material may be, for example, particulate.

The negative electrode active material is not particularly limited as long as it has a lower potential than that of the positive electrode active material. When the bipolar electrode laminated body of this disclosure is a bipolar electrode laminate for secondary lithium-ion batteries, examples that can be used for an anode active material include carbonaceous materials such as graphite (artificial graphite, natural graphite), resin carbon, carbon fiber, activated carbon, hard carbon, soft carbon, and so forth; metal-based materials primarily made of tin, tin alloys, silicon, silicon alloys, gallium, gallium alloys, indium, indium alloys, aluminum, aluminum alloys, and so forth; conductive polymers such as polyacene, polyacetylene, polypyrrole, and so forth; metallic lithium; lithium-titanium complex oxides such as L₄Ti₅O₁₂ and so forth; lithium alloys such as Li—Si alloys, Li—Sn alloys, Li—Al alloys, Li—Ga alloys, Li—Mg alloys, Li—In alloys, and so forth; and the like. These negative active substances may be used in one type alone or a combination of two or more types.

The content of the negative active material in the negative gating material as an electrode material may be more than 50% by mass, 70% by mass, more than 90% by mass, or more than 95% by mass.

The shape of the negative electrode active material may be, for example, particulate.

### Binder

When the battery according to the present disclosure is a lithium-ion secondary battery, examples of the binder include, but are not limited to, polyvinylidene fluoride (PVdF), polytetrafluoroethylene, polyethylene, polypropylene, aramid resin, polyamide, polyimide, polyamideimide, polyvinyl alcohol, polyacrylonitrile, polyacrylic acid, methyl polyacrylate, ethyl polyacrylate, hexyl polyacrylate, polymethacrylic acid, methyl polymethacrylate, ethyl polymethacrylate, polyhexyl methacrylate, polyhexyl methacrylate, polyvinyl acetate, polyvinyl pyrrolidone, polyether, polyether sulfone, polyhexafluoropropylene, styrene butadiene rubber, carboxymethyl cellulose, and so forth. These binders may be used singly or in a combination of two or more.

The content of the binder in the electrode mixture is not particularly limited, and can be appropriately set according to a desired binding property or the like.

### Conductive Aid

When the battery according to the present disclosure is a lithium-ion secondary battery, examples of the conductive auxiliary agent include, but are not limited to, graphites such as natural graphite, artificial graphite, and so forth; carbon blacks such as acetylene black, Ketjen black, channel black, furnace black, lamp black, thermal black, and so forth; conductive fibers such as carbon fibers like carbon nanotubes, metal fibers, and so forth; metal powders such as aluminum powder and so forth; conductive whiskers such as zinc oxide whiskers, conductive potassium titanate whiskers, and so forth; conductive metal oxides such as titanium oxide and so forth; organic conductive materials such as phenylene derivatives, and so forth; and the like. These conduction aids may be used in one single type or a combination of two or more types.

The content of the conductive auxiliary agent in the electrode mixture is not particularly limited, and can be appropriately set in accordance with desired conductivity or the like.

### Other Ingredients

The electrode mixture may contain components other than those described above. Examples of such a component include a solid electrolyte and a dispersant.

What is claimed is:

1. A manufacturing method of a battery, the manufacturing method comprising performing roller conveying, by a conveying roller, of a bipolar electrode laminate that is an elongated sheet and that is heated, wherein
the bipolar electrode laminate includes a first electrode active material layer, a current collector layer, and a second electrode active material layer, in this order,
the first electrode active material layer is made up of a plurality of island portions extending in a conveying direction, with at least one gap portion extending in the conveying direction among the island portions,
a temperature decrease of the bipolar electrode laminate when the bipolar electrode laminate passes over the conveying roller is no less than 30° C.,
the manufacturing method further comprising pressing the bipolar electrode laminate with a pressing roller prior to the bipolar electrode laminate passing over the conveying roller,
a temperature decrease of the bipolar electrode laminate when the bipolar electrode laminate passes over the pressing roller is less than 30° C., and
the pressing roller includes a protruding portion at a position overlapping with the gap portion or an opposite side face from the gap portion, such that stretching stress in a lateral direction is applied to the gap portion when the bipolar electrode laminate passes over the pressing roller.

2. The manufacturing method according to claim 1, wherein a width of the protruding portion is no greater than a width of the gap portion.

3. The manufacturing method according to claim 1, wherein a cross-sectional shape of the protruding portion is a rounded square.

4. The manufacturing method according to claim 1, further comprising drying the first electrode active material layer and the second electrode active material layer by laser heating prior to the pressing.

5. The manufacturing method according to claim 4, further comprising pressing the bipolar electrode laminate prior to the drying.
